(19) United States
(12) Patent Application Publication
(10) Pub. No.: US 2012/0082777 A1
(43) Pub. Date: Apr. 5, 2012

(54) METHOD OF PRODUCING PHOSPHOR FILM AND METHOD OF PRODUCING IMAGE DISPLAY APPARATUS

(75) Inventor: Ginta Hirasawa, Tokyo (JP)

(73) Assignee: CANON KABUSHIKI KAISHA, Tokyo (JP)

(21) Appl. No.: 13/233,811

(22) Filed: Sep. 15, 2011

(30) Foreign Application Priority Data
Oct. 1, 2010 (JP) 2010-223976

(51) Int. Cl. B05D 5/06

(52) U.S. Cl. 427/66

(57) ABSTRACT

A method of producing a phosphor film includes performing a first treatment wherein a suspension, in which a plurality of first particles having a median diameter that is equal to or smaller than 1/10 of a median diameter of a plurality of phosphor particles is dispersed in a dispersion medium, is applied to a first phosphor particle layer having the plurality of phosphor particles previously provided on a base substance, and subsequently the dispersion medium in the suspension is vaporized, thereby obtaining a second phosphor particle layer in which the plurality of first particles have been arranged in a space between the mutually adjacent phosphor particles. A binding solution is applied to the second phosphor particle layer, and a dispersion medium or a solvent contained in the binding solution is vaporized to bind the plurality of phosphor particles.

### BACKGROUND OF THE INVENTION

1. Field of the Invention

The present invention relates to a method of producing a phosphor film and a method of producing an image display apparatus using the phosphor film.

2. Description of the Related Art

It is known that a phosphor film containing multiple phosphor particles is used for a light emitting unit of an image display apparatus. A binding agent is utilized for the purpose of enhancing a binding strength between the phosphor particles.

It is publicly known that a surface of the phosphor particle is not entirely covered with the binding agent and the surface of the phosphor particle is partially exposed. Japanese Patent Application Laid-Open No. 2006-344610 discusses a method in which the phosphor particles are dispersed in a liquid, and a phosphor layer formation solution obtained by dissolving a metal compound in this liquid is applied to an inner surface of a translucent container. And, the metal compound is deposited near contact portions between the phosphor particles by drying the applied phosphor layer formation solution, and subsequently baked at high temperature to change the metal compound to a metal oxide. By this method, the metal oxide is arranged to adhere near the contact portions of the phosphor particles and partially expose the surface of the phosphor particle. Therefore, a phosphor layer that inhibits a large reduction of an initial luminous flux is obtained because the surface of the phosphor particle is not entirely covered with the metal oxide.

A binding force is not obtained sufficiently in some cases by the method discussed in Japanese Patent Application Laid-Open No. 2006-344610.

### SUMMARY OF THE INVENTION

Aspects of the present invention are directed to providing a method of producing a phosphor film that enhances a binding force between phosphor particles while inhibiting reduction of emission luminance of the phosphor film.

According to an aspect of the present invention, the method of producing the phosphor film includes performing a first treatment wherein a suspension, in which a plurality of first particles having a median diameter that is equal to or smaller than 1/10 of a median diameter of a plurality of phosphor particles is dispersed in a dispersion medium, is applied to a first phosphor particle layer having the plurality of phosphor particles previously provided on a base substance, and subsequently the dispersion medium in the suspension is vaporized, thereby obtaining a second phosphor particle layer in which the plurality of first particles have been arranged in a space between the mutually adjacent phosphor particles, performing a second treatment wherein a binding solution which is a liquid containing a binding agent is applied to the second phosphor particle layer and performing a third treatment wherein the dispersion medium or a solvent contained in the binding solution applied to the second phosphor particle layer is vaporized to bind the plurality of phosphor particles.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A to 1G are cross-sectional schematic views illustrating an example of a process for producing the phosphor film according to aspects of the present invention.

FIG. 2 is a cross-sectional view illustrating a state of a binding agent in an interspace between mutually adjacent phosphor particles when a first particle is not supplied.

FIG. 3 is a view comparing a binding strength and a relative luminance between the presence and absence of the first particle and between types of the binding agent.

FIG. 4 is a schematic view illustrating an image display apparatus.

FIG. 5 is a view comparing a binding force and the relative luminance between the presence and absence of the first particle.

FIG. 6 is a schematic view illustrating a method of measuring the binding force of the phosphor film.

### DESCRIPTION OF THE EMBODIMENTS

Various exemplary embodiments, features, and aspects of the invention will be described in detail below with reference to the drawings.

An outline of each process in the method of producing the phosphor film according to aspects of the invention will be described in detail below with reference to the drawings. A detail in each process will be described after description of the outline of each process.

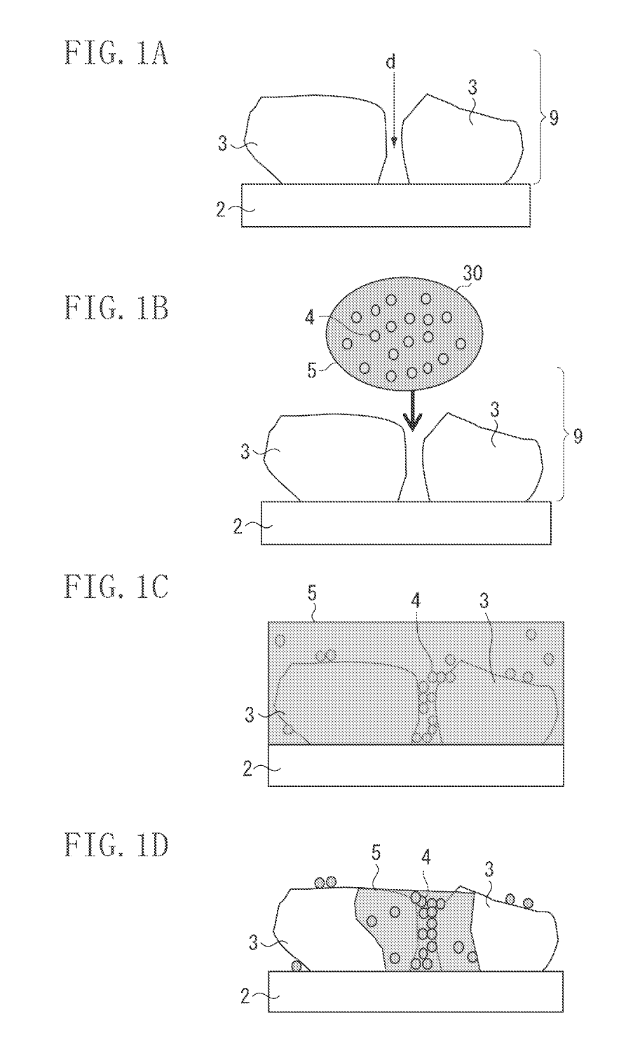

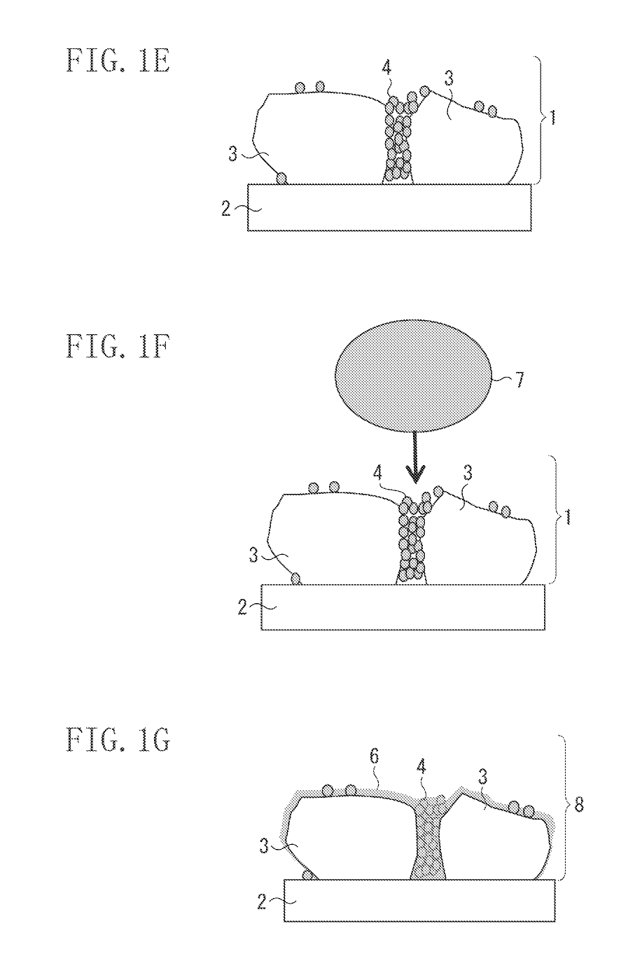

The outline of “process 1” will be described. First, as illustrated in FIG. 1A, a base substance previously provided with a first phosphor particle layer 9 having a plurality of phosphor particles 3 is prepared. When a plat-like member (i.e., a substrate) is used for the base substance 2, a glass substrate commonly used for liquid crystal display apparatuses and plasma display apparatuses can be utilized. For example, PD200 (manufactured by Asahi Glass Co., Ltd.) has a high strain point and is resistant to a high temperature process, so that it can be used as the glass substrate. Methods of previously providing the first phosphor particle layer 9 on the base substance 2 include, for example, applying a phosphor paste made by adding the phosphor particles 3 to a resin or an organic solvent to the base substance 2 by spin coating, dip coating or a dispenser, followed by baking it.

The outline of “process 2” will be described. Subsequently, as in FIG. 1E, a second phosphor particle layer 1 containing the plurality of phosphor particles 3 and a plurality of first particles 4 is obtained by arranging the multiple first particles 4 in the space d between the mutually adjacent phosphor particles provided on the base substance 2. The first particle 4 has a smaller median diameter than the median diameter of the phosphor particle 3, and the particle having the median diameter that is equal to or smaller than 1/10 of the median diameter of the multiple phosphor particles 3 can be utilized practically. Further, it is particularly useful if the median diameter of the first particle 4 is equal to or smaller than 1/20 of the median diameter of the multiple phosphor particles 3 because the first particles 4 suitably get into the space between the mutually adjacent phosphor particles. A definition of the median diameter will be described later. In the method of arranging the first particles 4, for example, a suspension 30 in which the first particles 4 is dispersed in a liquid (dispersion medium 5) is applied to the first phosphor particle layer 9 as in FIG. 1B. The second phosphor particle layer 1 in which the first particles 4 are arranged in the space between the mutually adjacent phosphor particles as in FIG. 1E is obtained by applying the suspension 30 to the first phosphor particle layer 9 followed by vaporizing the dispersion medium 5 contained in the suspension 30 (see FIGS. 1C and 1D).

The outline of “process 3” will be described. A binding solution 7 is applied to the second phosphor particle layer 1, after obtaining the second phosphor particle layer 1 by arranging the first particles 4 in the space between the mutually adjacent phosphor particles in “process 2”. In this case, the binding solution 7 to be applied is a liquid containing a binding agent 6. For example, binding solution in which the binding agent 6 is dissolved in a solvent (e.g., water glass and the like) or binding solution in which particles of the binding agent 6 are dispersed in the dispersion medium (e.g., silica sol and the like) can be utilized. A phosphor film 8 in which the phosphor particles 3 is bound each other by the binding agent 6 as shown in FIG. 1G is obtained by applying the binding solution 7 as shown in FIG. 1F followed by vaporizing the solvent or the dispersion medium contained in the binding solution 7.

Hereinafter, above each process will be described in detail.

First, “process 1” will be described.

The phosphor particle 3 and the first particle 4 that can be used according to aspects of the present invention will be described. For example, P22 phosphors (e.g., red [P22-RE3; Y₂O₂S: Eu³⁺], blue [P22-B2; ZnS: Ag, Al], green [P22-GN4; ZnS: Cu, Al] and the like) generally used for the image display apparatus using cathode-ray tubes (CRT) are available as materials of the phosphor particle 3 that can be used according to aspects of the present invention. In addition, the phosphors (e.g., red [YPVO₄: Eu, (Y, Gd) BO₃: Eu], blue [BaMgAl₁₀O₁₇: Eu, CaMgSi₂O₆: Eu], green [Zn₂SiO₄:Mn, (Y, Gd)BO₃:Tb, (Ba, Sr, Mg)O.aAl₂O₃: Mn] and the like) utilized for plasma display apparatuses can also be utilized. In addition, the phosphor materials composed of sulfide, acid sulfide, oxide or nitride can also be used. Such phosphors are described in, for example, “Phosphor Handbook” (edited by Keikotaidougakkai, published by Ohmsha in 1987). However, according to aspects of the present invention there is no limit as to the phosphors to be used as the phosphor particle 3 as long as those are phosphors.

The median diameter of the first particle 4 is smaller than the median diameter of the phosphor particle 3. Practically, the first particle 4 having the median diameter that is approximately equal to or smaller than 1/10 of the median diameter of the phosphor particle 3 is particularly useful because the first particle 4 easily gets into the space between the mutually adjacent phosphor particles 3.

The “median diameter” is a statistically calculated value defined by a particle diameter D when a volume of particles having a larger particle diameter than the particle diameter D occupies 50% of a volume of total particles in a particle diameter distribution, and typically denoted by D50. The above particle diameter distribution can be measured using a dynamic light scattering method or a laser diffraction scattering method. JIS Z8901: 2006 can be referred to for the particle diameter.

The median diameter of the phosphor particle 3 used for CRT and the plasma image display apparatus is often in the range from several μm to more than 10 μm in general, but the median diameter of the phosphor particle 3 applicable to aspects of the present invention is not necessarily limited thereto.

A shape of the first particle 4 to be used can be shape anisotropy, e.g., platy and needle-like, but an aspect ratio of the particle closer to 1 is more useful. This is because the larger the aspect ratio of the particle is, the less easily the particle enters the space between the mutually adjacent phosphor particles and the first particles 4, and after entering the space faces in random directions between the mutually adjacent phosphor particles, thereby hardly allowing the first particles 4 to be dense in the space between the mutually adjacent phosphor particles. For that matter, the closer the shape of the first particle 4 is to a sphere, the more easily the first particle 4 densely enters the space between the mutually adjacent phosphor particles, which is more useful.

When the phosphor film is used for the image display apparatus having an electron emitting device, a back scatter coefficient of the phosphor film 8 should be considered. The electron emitting device and the phosphor film 8 are commonly provided through vacuum. The phosphor particle 3 in the phosphor film 8 is excited by an electron which is emitted from the electron emitting device and incident on the phosphor film 8, and subsequently energy released by returning to a ground state is obtained as luminescence. When the electrons emitted from the electron emitter are incident on the phosphor particles 3 and the first particles 4 in the phosphor film 8, the incident electrons are partially scattered in each particle and emitted again into the vacuum (back scattering). The number of the electrons that contribute to the luminescence of the phosphor particle 3 is reduced by the back scattering, and thus, the luminescence luminance is reduced. Also when the electron scattered backward enters again the phosphor film, if the electron enters a location from a different location in which the electron is originally to be incident, this degrades an image quality. Therefore, to inhibit the back scatter in aspects of the present invention, it is useful that the back scatter coefficient of the first particle 4 is smaller than that of the phosphor particle 3. The back scattering coefficient is empirically obtained by (1nZ)/6−¼, where Z is an atomic number (cited from page 81 in Phosphor Handbook edited by Keikotaidougakkai, published by Ohmsha in 1987).

Materials of the first particle 4 are not particularly limited, and the materials which are difficult to be chemically bound to the phosphor particle 3 are useful. This is because the first particle 4 forming a strong chemical bond to the phosphor particle 3 adheres to the surface of the phosphor particle 3 before the first particle 4 is arranged in the space between the mutually adjacent phosphor particles, and is prevented from migrating into the space between the mutually adjacent phosphor particles. Sulfide, acid sulfide, oxide, or nitride is available as such a first particle 4. When the phosphor particle 3 of oxide, sulfide, or acid sulfide commonly used for the display such as CRT is used, silicon oxide, titanium oxide, or aluminum oxide is available as the useful material for the first particle 4 in terms of relationship of the back scattering coefficients between the phosphor particle 3 and the first particle 4 and because the chemical bond is difficult to form between them. It may be the case that the first particle 4 is a non-luminous particle that does not substantially emit the light compared with the phosphor. This prevents luminescence spectra of the first particle and the phosphor particle 3 from overlapping each other, which makes it difficult to obtain the phosphor film 8 having the desired luminescent property, when the first particle emits the light.

Subsequently, “process 2” will be described. First, the phosphor particles 3 are provided on the base substance 2, and then, the suspension in which the first particles 4 is dispersed in the liquid is applied to the first phosphor particle layer by applying the suspension in which the first particles 4 is dispersed in water or the organic solvent as the dispersion medium 5 using a spray method or a slit coating method. The dispersion medium 5 may have a low viscosity. Practically, the liquid having the viscosity equal to 0.3 mPa·S or more and equal to 20 mPa·S or less can be used. Such a liquid includes water, ethanol, isopropyl alcohol, propylene glycol monomethyl ether acetate, ethylene glycol, butyl carbitol acetate, methyl ethyl ketone, and xylene.

FIG. 1B is a schematic view illustrating a state in which the suspension in which the first particles 4 is dispersed is applied to the phosphor particles 3. The first particles 4 are dispersed in the suspension as shown in FIG. 1B. FIG. 1C is a schematic view representing a state immediately after applying the suspension to the first phosphor particle layer 9. As shown in FIG. 1C, the first particle gets into the space between the mutually adjacent phosphor particles in some cases at a stage before vaporizing the dispersion medium 5.

And, the dispersion medium 5 in the applied suspension needs to be vaporized. FIG. 1D is a schematic view illustrating a process of vaporizing the dispersion medium 5. Generally in the vaporization of the liquid, a surface area of the liquid influences a vaporization rate, and the area having the small surface area is hardly vaporized. Therefore, when the dispersion medium 5 is vaporized, the dispersion medium present in the space between the mutually adjacent phosphor particles cannot be dried easily compared with the dispersion medium 5 adhering onto the surface of the phosphor particle 3. Due to this nature, the dispersion medium 5 is vaporized from the surface of the phosphor particle in which vaporization easily progresses, and the volume of the dispersion medium 5 is reduced. In this case, the first particles 4 do not get into the space between the mutually adjacent phosphor particles and are yet dispersed in the dispersion medium 5 gather when the suspension is applied to the first phosphor particle layer 9. And then the first particles 4 gather together in the space between the mutually adjacent phosphor particles as a volume of the dispersion medium 5 reduces. As the dispersion medium 5 is vaporized as described above, the number of the first particles 4 arranged in the space between the mutually adjacent phosphor particles is increased. When the vaporization of the dispersion medium 5 is completed, the second phosphor particle layer 1 in which the first particles 4 is arranged in the space between the mutually adjacent phosphor particles is obtained as shown in FIG. 1D.

A heating condition for vaporizing the dispersion medium 5 is appropriately selected depending on types, concentrations and densities of the dispersion medium 5 and the first particle 4. To arrange the first particles 4 in the space between the mutually adjacent phosphor particles, it is necessary to control a moving velocity of the first particles 4 and a speed of vaporizing the dispersion medium 5. Specifically, when the heating temperature is high and the dispersion medium 5 is vaporized too rapidly relative to a possible moving velocity of the first particles 4, there is no sufficient time to allow the first particles 4 to move and many first particles 4 are left on the surface of the phosphor particles 3 in some cases. Therefore, a filling rate of the first particles 4 in the space between the mutually adjacent phosphor particles could be reduced. When the heating temperature is set near a boiling point of the dispersion medium 5 when the dispersion medium 5 is vaporized, bubbles are vigorously evolved from the dispersion medium 5 by the vaporization. These vigorously evolved bubbles can move the first particles 4, and the first particles 4 that get into the space between the mutually adjacent phosphor particles can break out of the space between the mutually adjacent phosphor particles in some cases. In some cases, the vigorously evolved bubbles inhibit the first particles 4 from getting into the space between the mutually adjacent phosphor particles along with the vaporization of the dispersion medium 5. On the other hand, when the speed of vaporizing the dispersion medium 5 is too slow, the first particles 4 settle out in the dispersion medium 5. Thus, it becomes difficult for the first particles 4 to move, and it may become difficult to arrange the first particles 4 in the space between the mutually adjacent phosphor particles. Therefore, it may be the case that the heating temperature for vaporizing the dispersion medium 5 is set to the temperature of 60% or more and 80% or less of the boiling point of the dispersion medium 5 as a rough standard when the dispersion medium 5 is vaporized.

The relationship between the particle diameters of the phosphor particle 3 and that of the first particle 4 is also important to suitably arrange the first particles 4 in the space between the mutually adjacent phosphor particles. A dispersion was prepared by changing the particle diameter of the first particles 4 and dispersing these particles in the liquid (dispersion medium 5). Then, this dispersion was spray-applied to the phosphor particles 3, and subsequently the dispersion medium 5 was vaporized. The state of the space between the mutually adjacent phosphor particles was observed with a scanning electron microscope (SEM). When the first particles 4 having the median diameter that was larger than 1/10 of the median diameter of the phosphor particle 3 were used, many first particles 4 were present on the surface of the second phosphor particle layer 1 although the first particles were present and arranged in the space between the mutually adjacent phosphor particles. On the other hand, when the first particles 4 having the median diameter that was equal to or smaller than 1/10 of the median diameter of the phosphor particle 3 were used, the first particles 4 were mostly arranged in the space between the pluralities of mutually adjacent phosphor particles. Thus, it was confirmed that the first particle easily got into the space between the mutually adjacent phosphor particles.

Subsequently, “process 3” will be described.

The method of applying a binding solution 7 to the second phosphor particle layer 1 is not particularly limited as long as the binding solution 7 can be applied to the phosphor particles 3 and the first particles 4, and a spray method, a screen printing method, a slit coating method, an application by a dispenser, and the like can be employed. In the binding solution 7 used in aspects of the present invention, particles that are the binding agent 6 can be dispersed in the dispersion medium, like a silica sol-based form, or the binding agent 6 can be dissolved in the solvent. When the binding solution 7 which disperses the particles (binding agent 6) in the liquid is used, it is useful that the median diameter of the binding agent 6 in the binding solution 7 is smaller than that of the first particle 4. This is because when the median diameter of the binding agent 6 is larger than that of the first particle 4, the binding agent 6 becomes difficult to get into the space among the first particles 4 and thus it becomes difficult to obtain the effect of enhancing the binding force. For example, WB-01A (manufactured by Asahi Glass Co., LTD.), PMA-ST (manufactured by Nissan Chemical Industries, Ltd.), IPA-ST (manufactured by Nissan Chemical Industries, Ltd.), Snowtex C (manufactured by Nissan Chemical Industries, Ltd.), and the like can be utilized as the silica sol-based form. Phosphate salts, alkali metal silicate salts, water glass, titanium oxide, and the like can be utilized as the binding agent other than the silica sol-based forms.

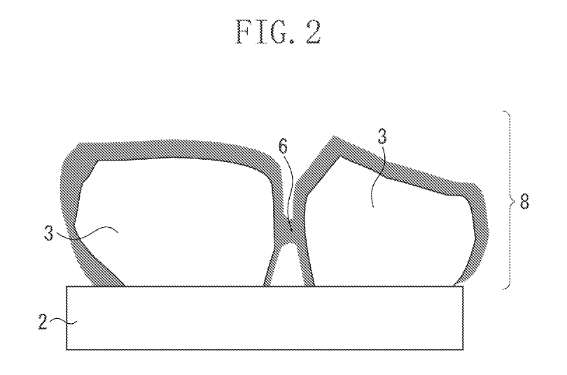

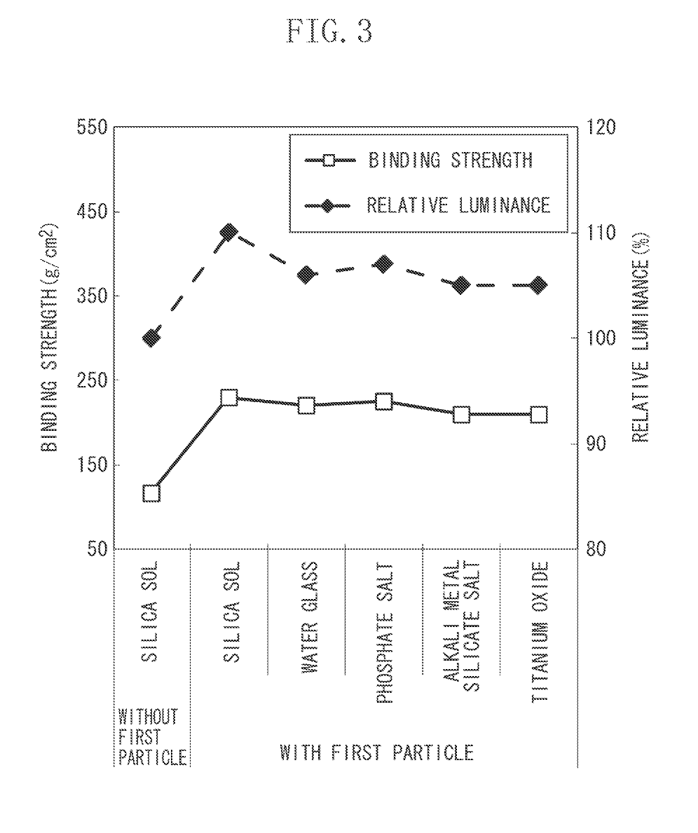

The binding solution 7 after being applied is heated to vaporize the solvent or the dispersion medium contained in the binding solution 7. The first particles 4 arranged in the space between the mutually adjacent phosphor particles have the effect to retain the binding solution 7 left in the space between the mutually adjacent phosphor particles. Specifically, the binding solution 7 tends to form a shape having a minimum surface area by a surface tension of the liquid, and thus easily moves to the space between the mutually adjacent phosphor particles, which is narrowed by arranging the first particles 4 in the process 2 (capillary phenomenon). By this capillary phenomenon, the binding agent 6 is retained in the space between the mutually adjacent phosphor particles, which has been narrowed by arranging the first particles 4, and can bind the phosphor particles each other well as shown in FIG. 1F. FIG. 2 is a schematic view illustrating a state of the adhering of the binding solution 7 when the first particle 4 is not applied. When the first particle 4 is not applied, the binding force between the phosphor particles becomes weak because an area in which the binding solution 7 can bind the phosphor particles each other is small. On the other hand, when the first particles 4 are present in the space between the mutually adjacent phosphor particles as shown in FIG. 1F, the area in which the binding agent 6 is retained is extended because the capillary phenomenon works strongly owing to the first particles 4 that narrow the space between the mutually adjacent phosphor particles. As is found by comparing the state of the binding agent 6 in the space between the mutually adjacent phosphor particles in FIG. 1F and FIG. 2, an amount of the binding agent 6 retained in the space between the mutually adjacent phosphor particles is increased compared with a case where the first particle 4 is not applied, and the binding force among the phosphor particles 3 is strengthened. Therefore, while a large amount of the binding agent 6 is required to increase the binding force when the first particle 4 is not applied, the required amount of the binding agent 6 can be reduced by introducing the first particles 4 in the space between the mutually adjacent phosphor particles. Thus, an extra amount of the binding agent 6 that covers the surface of the phosphor particle 3 is also reduced, so that the degradation of the luminescence luminance is inhibited.

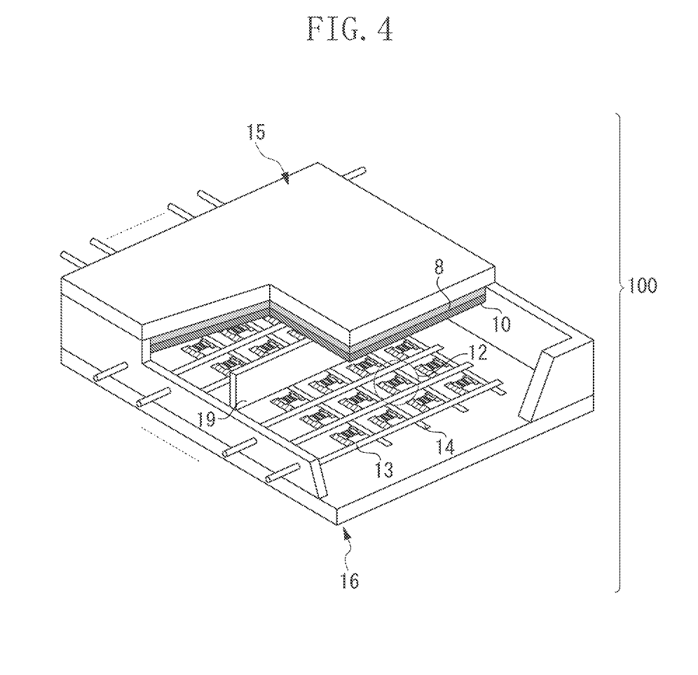

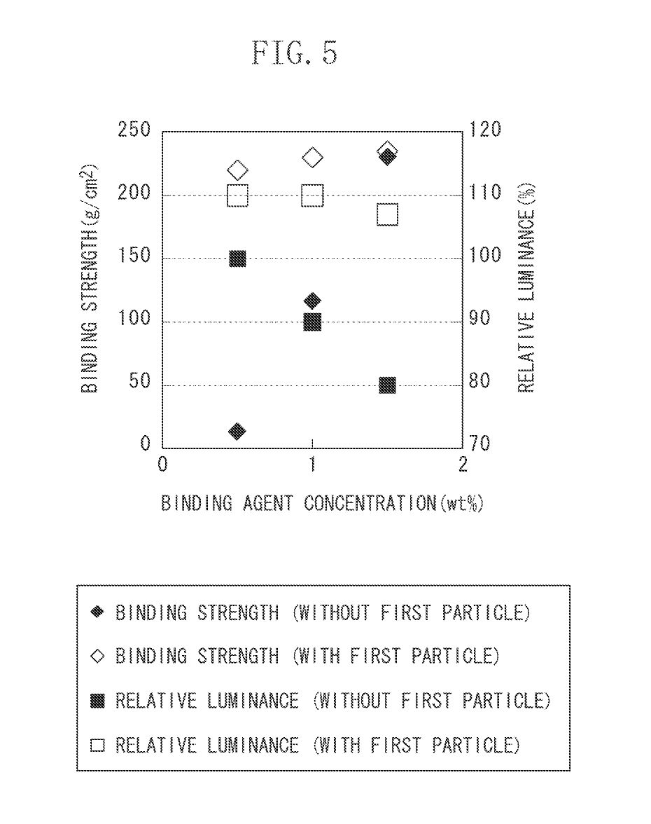

Next, one example of the image display apparatus using the phosphor film will be described. Here, the example using a surface-conduction electron emitting device is described as the image display apparatus, but the image display apparatus using the phosphor film according to aspects of the present invention is not limited thereto. Specifically, the phosphor film according to aspects of the present invention can be used for the image display apparatus that has an excitation source which can excite the phosphor of an electron emitting source/ultraviolet ray emitting source and obtains the luminescence by irradiating the phosphor film with the electron or the ultraviolet ray. FIG. 4 shows an entire outline of the image display apparatus 100 of the present exemplary embodiment, and is a perspective view which takes off a portion of the apparatus to show an inner structure. A rear plate 16 is provided with a plurality of the surface-conduction electron emitting devices 12, and the surface-conduction electron emitting devices are wired in matrix with an X directed wiring 13 and a Y directed wiring 14. The X directed wiring 13 and the Y directed wiring 14 are connected to a driving circuit (not shown) provided in an outer portion of the image display apparatus 100. This driving circuit gives a scanning signal that sequentially drives a surface-conduction electron emitting device group wired in matrix to the X directed wiring 13 line by line. A modulating pulse signal that controls an electron emitting output of each emitter of the surface-conduction electron emitting device group in the line selected by the scanning signal is given to the Y directed wiring 14.

A phosphor film 8 is formed on a face plate 15, and emits the light when irradiated with the electron emitted from the surface-conduction electron emitting device 12. An anode electrode 10 overlapping with the phosphor film 8 is referred to as a metal back, and a voltage that accelerates the electron from the rear plate 16 is applied thereto. Al and the like are used for the metal back.

A spacer 19 as an atmospheric pressure resistant structure is disposed between the rear plate 16 and the face plate 15. The spacer 19 is disposed between the mutually adjacent phosphor films 8 not to affect a displayed image of the image display apparatus 100, and abut on the face plate 15. The face plate obtained as described above is assembled opposed to the rear plate 16 having the surface-conduction electron emitting device 12 and bonding peripheral portion to form a vacuum container.

Electrons are emitted, which come into collision with the phosphor film 8 to emit the light from the phosphor film 8 and display the image when the voltage from a high voltage terminal not shown in the figure is applied to the anode electrode 10 and the surface-conduction electron emitting devices 12 are driven to emit the electrons.

Aspects of the present invention will be described with reference to following exemplary examples.

A first example will be described below with reference to FIG. 1.

“process 1” was carried out as follows. A phosphor paste (manufactured by Fuji Shikiso Kogyo K.K.) was screen-printed on a surface of washed PD200 glass substrate 2 (manufactured by Asahi Glass Co., Ltd.). In a composition of the paste, an ethyl cellulose resin was used as a binder, diethylene glycol monomethyl ether acetate (BCA) and terpineol (TPO) were used as solvents, and red [P22-RE3; Y₂O₂S: Eu³⁺] that is P22 phosphor was used as a phosphor particle. A median diameter of the particle was 6.0 μm. The “process 1” can be carried out also for the blue [P22-B2; ZnS: Ag, Al] and the green [P22-GN4; ZnS: Cu, Al] as the P22 phosphors. When white luminescence is obtained by using the plurality of phosphors of red, blue and green, the step of the present example can be carried out by utilizing the phosphor paste obtained by mixing the plurality of phosphors.

Subsequently, the phosphor paste was dried at 120° C. for 10 minutes and baked at 500° C. for 90 minutes to remove organic components such as a solvent and a resin in the phosphor paste and provide a first phosphor particle layer 9 having the plurality of phosphor particles 3 on the glass substrate 2.

Subsequently, a suspension in which silica beads (Hipresica FQ manufactured by Ube Nitto Kasei Co., Ltd.) as first particles 4 had been dispersed in water was prepared, and applied to the first phosphor particle layer 9 by a spray method. A median diameter of the first particles 4 was 0.2 μm. Subsequently, water that was a dispersion medium 5 was vaporized under an atmospheric pressure at 70° C. for 30 minutes to obtain a second phosphor particle layer 1 in which the silica beads that were the first particles 4 were arranged in the space between the mutually adjacent phosphor particles.

“Process 2” was carried out as follows. A binding solution 7 was applied to the second phosphor particle layer 1 by the spray method. PMA-ST (manufactured by Nissan Chemical Industries, Ltd.) was used as the binding solution 7. In the composition of the binding solution 7, colloidal silica was used as a binding agent 6 and polyethylene glycol monomethyl ether acetate (PMA) was used as the dispersion medium. The concentration of the binding agent 6 was 1.3 wt %. The median diameter of colloidal silica was 20 nm. Subsequently, PMA that was the dispersion medium in the binding solution 7 was vaporized at 170° C. for 10 minutes. Then, the baking at 500° C. for 90 minutes was carried out to remove the organic component remaining in the binding agent 6.

A binding strength and the luminance of the produced phosphor film 8 and a phosphor film produced in the same manner as in example 1 except the first particle which was not applied were evaluated. The used amount of the binding solution 7 was constant regardless of the presence or absence of the first particle 4. The binding strength was measured by attaching a masking tape 851A (manufactured by 3M) to the phosphor film and subjecting a obtained piece to a tensile tester (manufactured by Aikoh Engineering Co., Ltd.). And then a tensile strength was measured. As a result, the phosphor film 8 according to aspects of the present invention has improved in the binding strength that became equal to 20% or greater than that of the phosphor film in comparative example.

The aforementioned image display apparatus was formed using a face plate comprising the phosphor film 8 produced in the same manner as in the method of present example and the phosphor film produced in the same manner as in the method of comparative example, and their luminance was compared. The image display apparatus was driven by setting a driving acceleration voltage to 10 kV, and the luminance of the phosphor film was measured by a luminance measuring equipment. As a result, the image display apparatus using the phosphor film 8 to which the first particle 4 had been applied had the luminance that increased to be equal to 7% or greater than that using the phosphor film produced without giving the first particle 4.

A second exemplary example will be described. A phosphor film was produced using silica sol WB-01A (manufactured by Asahi Glass Co., Ltd.), water glass (manufactured by Sanko Colloid Chemical Co., Ltd.), a magnesium phosphate salt (manufactured by Taihei Chemical Industrial Co., Ltd.), a potassium silicate salt (manufactured by Fuji Chemical Industry Co., Ltd.), and titanium oxide (manufactured by Nippon Aerosil Co., Ltd., median diameter: 30 nm), each fixed at a concentration of 1 wt %, as the binding agent 6, and their binding strength was evaluated.

The step carried out in present example is the same as “process 1” and “process 2” in the first example, except for a heating condition for vaporizing the dispersion medium or the solvent in the binding solution 7. After applying the binding solution 7, the dispersion medium (water) was vaporized when the silica sol or titanium oxide was used as the binding agent 6, and the solvent (water) was vaporized when the water glass, the magnesium phosphate salt, or the alkali metal silicate salt was used as the binding agent 6. The heating was carried out at 70° C. for 30 minutes so that bubbles produced by boiling the water when the water was vaporized did not move the first particles 4 that had gotten into the space between the mutually adjacent phosphor particles.

The binding strength and the luminance of the phosphor films obtained as above were evaluated in the same manner as in example 1.

Results of the evaluation are shown in FIG. 3. Both the binding strength and the luminance were much greater in the phosphor films using all of the binding agents to which the first particle had been applied than in the phosphor films produced without applying the first particle.

As described above, by arranging the first particles in the space between the mutually adjacent phosphor particles, the phosphor film having the strong binding force among the spaces between the mutually adjacent phosphor particles and the high luminance similar to example 1 could be produced regardless of the type of the binding agent 6.

A third exemplary example will be described. In the present example, a phosphor film was used for the aforementioned image display apparatus. The phosphor film 8 was produced in the same procedure as in example 1 except for a concentration condition of the binding agent 6, and the binding strength of the produced phosphor film was evaluated. The phosphor film 8 was produced on the face plate 15 in the image display apparatus in the same procedure as in example 1 except a material for the first particle 4 and the condition for the binding agent 6. The material used here for the first particle was silicon oxide, and its median diameter was 0.3 μm. The binding solution 7 used was silica sol WB-01A (manufactured by Asahi Glass Co., Ltd.).

The concentration of the binding agent 6 in the binding solution 7 was 0.5, 1.0 and 1.5 wt %.

The image display apparatus shown in FIG. 4 was assembled using the produced phosphor film 8 and driven to measure its luminance.

To measure the binding strength, the phosphor film 8 was separately produced in the same process as that of producing the phosphor film 8 for measuring the luminance. The binding strength of the phosphor film was evaluated by attaching a masking tape to this phosphor film 8, peeling the tape using the tensile tester, and measuring the strength when the tape was peeled from the substrate.

When making evaluations, the phosphor film was produced without applying the first particle as a comparative example, and the binding strength and the luminance were compared in a state of the presence and the absence of the first particle.

The results of the evaluation are shown in FIG. 5. A relative luminance in the figure indicates a value obtained based on the luminance measured in the phosphor film produced using the binding agent 6 at a concentration of 0.5 wt % in the comparative example.

When the first particle was not applied, the binding strength was increased as the concentration of the binding agent 6 was increased, but the relative luminance was decreased as the concentration of the binding agent 6 was increased. On the other hand, when the first particle was applied, the phosphor film had the high binding strength equal to 200 g/cm² or more even when the concentration of the binding agent 6 was low. The relative luminance was almost constant regardless of the concentration of the binding agent 6. The phosphor film had higher luminance than those obtained using the binding agent 6 at any concentration in a case where the first particle was not applied.

From the result of above evaluating, it can be concluded that the phosphor film of the present example has the high binding force and prevents the luminance from lowering while reducing the concentration of the binding agent 6, when the first particles are applied.

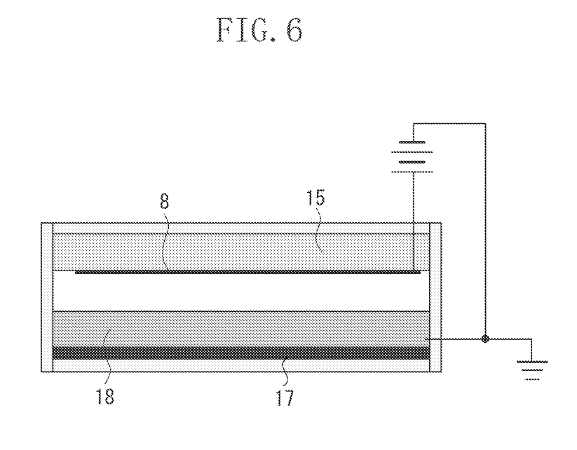

A fourth exemplary example will be described. A phosphor film 8 was produced on a face plate 15 usable for the image display apparatus as in FIG. 6 using silicon oxide, aluminum oxide, or titanium oxide as the first particle according to the process described in example 1. The median diameter of the particle was 0.2 μm for silicon oxide, 0.2 μm for titanium oxide, and 0.4 μm for aluminum oxide. The binding solution 7 included the binding agent 6 which is the Silica sol WB-01A (manufactured by Asahi Glass Co., Ltd.) as and the concentration was 1.3 wt %. An opposite electrode 17 and a dielectric body 18 shown in FIG. 6 were set at a distance of 2 mm from the face plate 15, on this substrate. To insulate the face plate 15 and the opposite electrode 17 from each other, an internal pressure in the apparatus was made equal to 5×10⁻³ Pa or less, further the voltage applied to the opposite electrode 17 was set to 15 kV, and these were kept for 10 minutes.

To evaluate the binding strength of the phosphor film 8, the number of phosphor particles adhering onto the dielectric body 18 after completing the voltage application was counted using a particle counter. The results of the measurement are shown in the following Table.

TABLE 1

| | No first | Silicon | Aluminum | Titanium |
|---|---|---|---|---|
| | particle | Oxide | oxide | oxide |
| Number of | 254 | 2 | 7 | 5 |
| phosphor | | | | |
| particles | | | | |
| on | | | | |
| dielectric | | | | |
| body 18 | | | | |

In the phosphor film produced without giving the first particle, 254 phosphor particles fell. On the other hand, when the first particle was applied, equal to 10 or less of the phosphor particles fell in any case of using silicon oxide, aluminum oxide, or titanium oxide as the binding agent 6. Therefore, dropout of the phosphor film due to a coulomb force generated by the voltage application was remarkably inhibited. Thus, the phosphor film with the enhanced binding strength was obtained by arranging the first particles in the space between the mutually adjacent phosphor particles.

A fifth exemplary example will be described. The first phosphor particle layer was provided on washed PD200 glass substrate in the same manner as in example 1, and subsequently a suspension in which silica beads (Hipresica FQ manufactured by Ube Nitto Kasei Co., Ltd.) had been dispersed in water was prepared, and applied to the phosphor particles by the spray method. The median diameter of the used first particle was 0.2 μm. Subsequently, the water that was the dispersion medium was vaporized under the atmospheric pressure at 100° C. for 30 minutes. The resulting second phosphor particle layer was observed with the SEM, and the first particles arranged in the space between the mutually adjacent phosphor particles were identified. However, the amount of the first particles arranged in the space between the mutually adjacent phosphor particles was smaller than that in example 1, and the first particles dominantly adhered to the surface of the second phosphor particle layer.

A sixth exemplary example will be described. The first phosphor particle layer was provided on washed PD200 glass substrate in the same manner as in example 1, and subsequently the suspension in which silica beads (Hipresica FQ manufactured by Ube Nitto Kasei Co., Ltd.) had been dispersed in water was prepared, and applied to the phosphor particles by the spray method. The median diameter of the first particle used was 0.2 μm. Subsequently, the water that was the dispersion medium was vaporized under the atmospheric pressure at 50° C. for 600 minutes. The resulting second phosphor particle layer was observed with the SEM, and the first particles arranged in the space between the mutually adjacent phosphor particles were identified. However, many aggregates of the first particles were observed on the surface of the second phosphor particle layer. The amount the first particles arranged in the space between the mutually adjacent phosphor particles was smaller than in the second phosphor particle layer obtained in example 1.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-223976 filed Oct. 1, 2010, which is hereby incorporated by reference herein in its entirety.

What is claimed is:

1. A method of producing a phosphor film comprising:
performing a first treatment wherein a suspension, in which a plurality of first particles having a median diameter that is equal to or smaller than 1/10 of a median diameter of a plurality of phosphor particles is dispersed in a dispersion medium, is applied to a first phosphor particle layer having the plurality of phosphor particles previously provided on a base substance, and subsequently the dispersion medium in the suspension is vaporized, thereby obtaining a second phosphor particle layer in which the plurality of first particles have been arranged in a space between mutually adjacent phosphor particles;
performing a second treatment wherein a binding solution that is a liquid containing a binding agent is applied to the second phosphor particle layer; and
performing a third treatment wherein the dispersion medium or a solvent contained in the binding solution applied to the second phosphor particle layer is vaporized to bind the plurality of phosphor particles.

2. The method of producing the phosphor film according to claim 1, wherein the dispersion medium in the suspension is vaporized at temperature that is equal to or greater than 60% and equal to or smaller than 80% of a boiling point of the dispersion medium in the first treatment.

3. The method of producing the phosphor film according to claim 1, wherein the plurality of phosphor particles includes at least one of particles of oxide, sulfide, and acid sulfide, and the plurality of first particles includes at least one of silicon oxide, titanium oxide, and aluminum oxide.

4. The method of producing the phosphor film according to claim 1, wherein the median diameter of the plurality of first particles is equal to or smaller than 1/20 of the median diameter of the plurality of phosphor particles.

5. A method of producing an image display apparatus that has a phosphor film and an excitation source that allows the phosphor film to emit light comprising:
producing the phosphor film by the method according to claim 1.
